(19) United States
(12) Patent Application Publication
(10) Pub. No.: US 2018/0053397 A1
(43) Pub. Date: Feb. 22, 2018

(54) ACTIVATING AN ALARM IF A LIVING BEING IS PRESENT IN AN ENCLOSED SPACE WITH AMBIENT TEMPERATURE OUTSIDE A SAFE TEMPERATURE RANGE

(71) Applicant: Ent. Services Development Corporation LP, Houston, TX (US)

(72) Inventors: Satwant KAUR, Mountain View, CA (US); Larry SCHMIDT, Rutledge, GA (US)

(73) Assignee: Ent. Services Development Corporation LP, Houston, TX (US)

(21) Appl. No.: 15/555,877

(22) PCT Filed: Mar. 5, 2015
(86) PCT No.: PCT/US15/18865

§ 371 Date: Sep. 5, 2017

(51) Int. Cl. G08B 21/22; G08B 21/24; G08B 21/04

(52) U.S. Cl. CPC G08B 21/22; G08B 21/0469; G08B 21/24

(57) ABSTRACT

Example implementations relate to activating an alarm if a living being is present in an enclosed space having an ambient temperature outside a safe temperature range. In example implementations, it may be determined whether a living being has been present in an enclosed space, and an ambient temperature of the enclosed space has been outside a safe temperature range, for a threshold amount of time. An alarm may be activated if the living being has been present in the enclosed space, and the ambient temperature of the enclosed space has been outside the safe temperature range, for the threshold amount of time.

### BACKGROUND

Passive thermal sensors may detect electromagnetic radiation, such s infrared light, from objects in their field of view. Passive thermal sensors placed in vehicles or around residences may be used to detect the presence of humans or animals. Passive thermal sensors may also be used to determine the ambient temperature of an environment.

### BRIEF DESCRIPTION OF THE DRAWINGS

The following detailed description references the drawings, wherein:

FIG. 1 is a block diagram of an example system for activating an alarm when a living being in an enclosed space is subject to extreme temperatures;

FIG. 2 is a block diagram of an example system for determining whether a living being is present in an enclosed space;

FIG. 3 is a block diagram of an example device that includes a machine-readable storage medium encoded with instructions to enable activation of an alarm when a living being in an enclosed space is subject to extreme temperatures;

FIG. 4 is a block diagram of an example device that includes a machine-readable storage medium encoded with instructions to enable communication with an emergency service if a living being in an enclosed space is subject to extreme temperatures;

FIG. 5 is a flowchart of an example method for activating an alarm when a living being in an enclosed space is subject to extreme temperatures; and

FIG. 6 is a flowchart of an example method for notifying an emergency service if a living being in an enclosed space is subject to extreme temperatures.

### DETAILED DESCRIPTION

Passive thermal sensors may be used to detect the presence of living beings. As used herein, the term “passive thermal sensor” should be understood to refer to a sensor that detects and/or measures electromagnetic radiation in the sensor's field of view without generating or radiating any energy for detection or measurement purposes. Examples of passive thermal sensors include passive infrared detectors and pyroelectric infrared (PIR) sensors. As used herein, the term “living being” should be understood to refer to a human or animal.

Living beings with limited mobility and/or physical capabilities may be left unattended in enclosed spaces. For example, pets, young children, or elderly people may be left unattended in a car while the driver of the car runs an errand. As used herein, the term “enclosed space” should be understood to refer to a receptacle, room, or vehicle that can fit a living being. Examples of enclosed spaces include cars, pet containers, and hospital rooms. Over time, the ambient temperature in an enclosed space may rise or drop to a level that is unsafe for a living being inside the enclosed space. For example, on a hot summer day, the temperature inside a car may rise quickly after the car engine is turned off, putting a pet or child left in the car at risk of heat stroke if the driver of the car leaves for more than a few minutes. The pet or child may not be able to open the car doors or windows, and may not be able to call for help. In light of the above, the present disclosure provides for automatic activation of an alarm if a living being is in an enclosed space with an unsafe ambient temperature for a certain period of time. Thus, an entity outside the enclosed space may be notified of the potential harm to the living being, and may remove the living being from the enclosed space and/or restore the ambient temperature to a safe temperature before adverse effects set in.

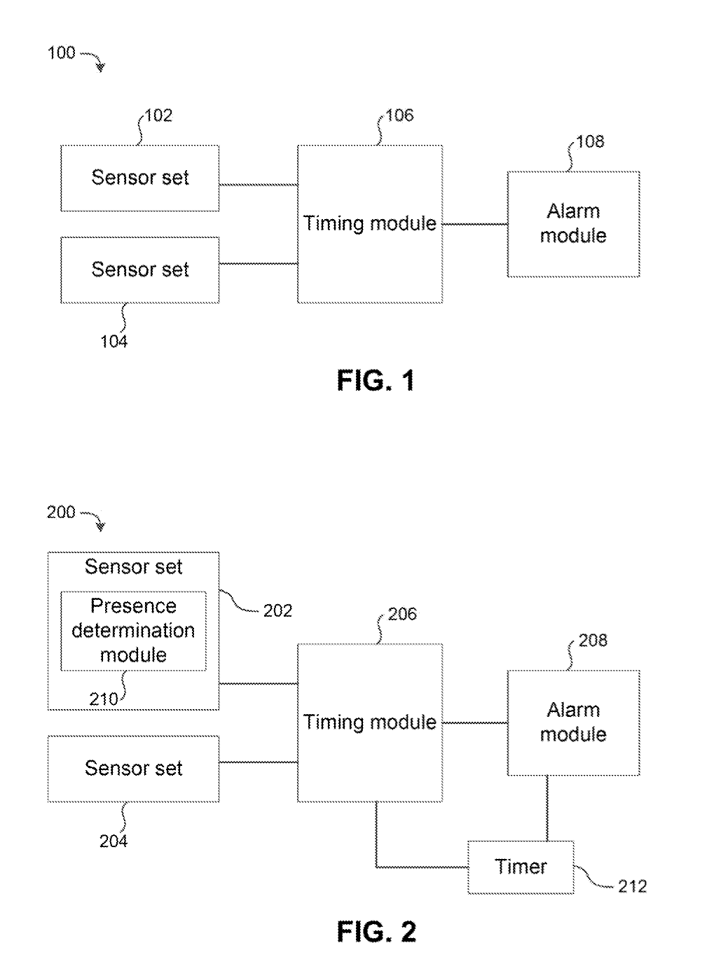

Referring now to the figures, FIG. 1 is a block diagram of an example system 100 for activating an alarm when a living being in an enclosed space is subject to extreme temperatures. System 100 may be implemented in an enclosed space, such as, but not limited to, a vehicle, a pet container, or a room in a medical facility. In FIG. 1, system 100 includes sensor set 102, sensor set 104, timing module 106, and alarm module 108. As used herein, the terms “include”, “have”, and “comprise” are interchangeable and should be understood to have the same meaning. A module may include a set of instructions encoded on a machine-readable storage medium and executable by a processor. In addition or as an alternative, a module may include a hardware device comprising electronic circuitry for implementing the functionality described below.

Sensor set 102 may determine whether a living being is present in an enclosed space. In some implementations, sensor set 102 may detect motion to determine whether a living being is present in an enclosed space. Sensor set 102 may be sensitive to very small motions, such that movement resulting from a living being breathing may be detected. In some implementations, sensor set 102 may determine relative or absolute temperatures in its field of view.

Sensor set 104 may determine whether an ambient temperature of the enclosed space is outside a safe temperature range. A safe temperature range may be a range of ambient temperatures that do not pose a health risk to a living being. Sensor set 104 may be programmed with a default safe temperature range. In some implementations, the safe temperature range may be modified by a person associated with the enclosed space (e.g., a driver of a vehicle if the enclosed space is a vehicle, an owner of the pet inside a pet container if the enclosed space is a pet container, a doctor or nurse if the enclosed space is a room in a medical facility). Different living beings may have different safe temperature ranges, and a safe temperature range may be adjusted based on what type of living being system 100 will be used for. For example, a pet dog may have a higher average body temperature than a human baby, and thus the maximum temperature of a safe temperature range for the dog may be higher than the maximum temperature of a safe temperature range for the baby.

Sensor sets 102 and 104 may include passive thermal sensors. For example, sensor sets 102 and 104 may include pyroelectric infrared (PIR) sensors. Any passive thermal sensor suitable for detecting the presence of a living being and/or determining an ambient temperature may be used. Each of sensor sets 102 and 104 may include one passive thermal sensor, or multiple passive thermal sensors. For example, if sensor set 102 is inside a car, sensor set 102 may include multiple sensors so that the car's front seats, back seats, and the floors in front of the front and back seats are in the collective field of view of (i.e., the combination of the fields of view of all sensors in) sensor set 102. Sensor sets 102 and 104 may have different numbers of sensors.

Timing module 106 may be communicatively coupled to sensor sets 102 and 104. Timing module 106 may determine whether a living being has been present in an enclosed space, and the ambient temperature of the enclosed space has been outside a safe temperature range, for a threshold amount of time. In some implementations, timing module 106 may (periodically) receive data from sensor sets 102 and 104 indicating whether a living being is present and whether the ambient temperature is outside the safe temperature range, respectively. Timing module 106 may determine, based on such data, whether both the conditions of a living being's presence and an ambient temperature outside the safe temperature range have been concurrently satisfied continuously for the threshold amount of time. In some implementations, a default threshold amount of time may be programmed into timing module 106, and may be modified by a person associated with the enclosed space (e.g., a vehicle/pet owner, medical staff).

Alarm module 108 may be communicatively coupled to timing module 106. Alarm module 108 may activate an alarm if a living being has been present in an enclosed space, and the ambient temperature of the enclosed space has been outside the safe temperature range, for the threshold amount of time. The alarm may draw the attention of a person outside the enclosed space so that the living being can be removed from the enclosed space and/or the ambient temperature of the enclosed space can be raised/lowered to a temperature within the safe temperature range, preventing harm that the living being may have suffered due to extreme temperatures.

In some implementations, the activated alarm may include flashing lights along an exterior surface of the enclosed space. For example, if the enclosed space is a vehicle, alarm module 108 may flash the vehicle's headlights and/or tail lights to attract attention to the living being inside the vehicle. If the enclosed space is a pet container, alarm module 108 may be communicatively coupled to lights attached to an outer surface of the container, and may flash such lights if an animal has been present inside the container, and the ambient temperature of the container has been outside a safe temperature range, for a threshold amount of time. In some implementations, the lights may flash in the pattern of a distress signal (e.g., “SOS” in Morse code). lf the enclosed space is a vehicle, the vehicle's lights and horn may be flashed and sounded, respectively, in the pattern of a distress signal. Such a pattern may be different than the pattern used when the vehicle's theft alarm is triggered by forced entry, such that bystanders can differentiate between the vehicle being stolen and someone/something inside the car being at risk of overheating/hypothermia.

In some implementations, the activated alarm may include playing a pre-recorded message through a speaker along an exterior surface of the enclosed space. For example if the enclosed space is a vehicle or pet container, the pre-recorded message may say that a person or animal inside the vehicle or pet container is in danger from extreme temperatures. Alarm module 108 may be programmed with a default message, and in some implementations, a custom message may be pre-recorded (e.g., by a vehicle/pet owner).

In some implementations, the activated alarm may include a text or audio alert transmitted from alarm module 108 to a user device of a person associated with the enclosed space. For example, if the enclosed space is a vehicle, alarm module 108 may send a text message to a smartphone carried by the owner of the vehicle, or call the smartphone with a pre-recorded message that may be left as a voicemail if the owner does not answer the call. Alternatively or in addition, alarm module 108 may cause the smartphone or other user device to beep or vibrate to attract the owner's attention. In some examples, the enclosed space may be a pet container, and the person associated with the enclosed space may be the owner of the pet inside the pet container. Alarm module 108 may call, text, and/or otherwise activate a user device carried by the pet owner, as discussed above. In some examples, the enclosed space may be a room inside a medical facility, and the person associated with the enclosed space may be a staff member (e.g., doctor or nurse) who works in the facility. Alarm module 108 may text or call a smartphone carried by the staff member, or cause a pager carried by the staff member to beep or vibrate. Any other suitable form of notification may be used.

In some implementations, alarm module 108 may automatically contact an emergency service if the person associated with the enclosed space does not respond to the text or audio alert within a response time interval after the text or audio alert is transmitted to the user device. The person may respond to the text or audio alert by, for example, answering a call, listening to a voicemail, or opening a text message transmitted by alarm module 108. if the person does not respond within the response time interval, alarm module 108 may contact, for example, a police station, emergency medical technician (EMT) unit, or hospital near the enclosed space. In some implementations, alarm module 108 may use Global Positioning System (GPS) capabilities, if available in the enclosed space (e.g., GPS device built into a car), to determine which emergency service to contact (e.g., alarm module 108 may determine the location of the enclosed space and contact the nearest emergency service), and may transmit GPS coordinates of the enclosed space to the emergency service that is contacted. In some implementations, alarm module 108 may contact an entity that can access and/or control the ambient temperature of the enclosed space. For example, if the enclosed space is a pet container in the cargo area of an airplane, alarm module 108 may contact the cockpit of the airplane and/or a flight control system.

In some implementations, sensor sets 102 and 104, timing module 106, and alarm module 108 may all be in an enclosed space. In same implementations, sensor sets 102 and 104 may be in an enclosed space, and timing module 106 and/or alarm module 108 may be in a remote location from the enclosed space. For example, timing module 106 and/or alarm module 108 may be implemented in a remote server that is communicatively coupled to sensor sets 102 and 104. In some implementations, timing module 106 and alarm module 108 may be in different remote locations. In some implementations, alarm module 108 may activate a combination of the alarms described above.

FIG. 2 is a block diagram of an example system 200 for determining whether a living being is present in an enclosed space. System 200 may be implemented in an enclosed space, such as, but not limited to, a vehicle, a pet container, or a room in a medical facility. In FIG. 2, system 200 includes sensor set 202, sensor set 204, timing module 206, alarm module 208, and timer 212.

Sensor sets 202 and 204 may include passive thermal sensors. A module may include a set of instructions encoded on a machine-readable storage medium and executable by a processor. In addition or as an alternative, a module may include a hardware device comprising electronic circuitry for implementing the functionality described below. Timing module 206 and alarm module 208 may be analogous to (e.g., have functions and/or components similar to) timing module 106 and alarm module 108, respectively, of FIG. 1.

Sensor set 202 may determine whether a living being is present in an enclosed space. Sensor set 204 may determine whether an ambient temperature of the enclosed space is outside a safe temperature range. Sensor sets 202 and 204 may perform any of the functions discussed above with respect to sensor sets 102 and 104, respectively, of FIG. 1 In some implementations, sensor sets 202 and 204 may determine absolute temperatures in the respective fields of view of sensor sets 202 and 204. Timing module 206 may be communicatively coupled to sensor sets 202 and 204, and may determine whether a temperature of the living being and the ambient temperature of the enclosed space diverge for a predetermined amount of time. If the temperature of the living being and the ambient temperature of the enclosed space diverge for the predetermined amount of time, alarm module 208 may activate an alarm. Such a temperature divergence within the predetermined amount of time may indicate that the ambient temperature of the enclosed space is changing too quickly for the living being to adjust, and thus the living being may be in danger. The activated alarm may take any or a combination of of the forms discussed above with respect to FIG. 1.

In some implementations, sensor set 202 may include presence determination module 210. Presence determination module 210 may determine temperatures in different areas of a field of view of sensor set 202. Presence determination module 210 may identify an area of the field of view that has a different temperature than other areas of the field of view, and determine whether the identified area includes a living being. For example, presence determination module 210 may identify a region of the field of view that has a higher average temperature than other regions of the field of view, and determine that such a higher average temperature is consistent with the body temperature of a living being.

In some implementations, if sensor set 202 determines that a living being is present in an enclosed space, sensor set 202 may transmit, to timing module 206, a signal indicative of the living being's presence. If sensor set 204 determines that the ambient temperature of the enclosed space is outside a safe temperature range, sensor set 204 may transmit, to timing module 206, a signal indicative of the ambient temperature being outside the safe temperature range. In response to receiving the signal indicative of the living being's presence after receiving the signal indicative of the ambient temperature being outside the safe temperature range, or in response to receiving the signal indicative of the ambient temperature being outside the safe temperature range after receiving the signal indicative of the living being's presence. timing module 206 may start timer 212. Alarm module 208 may activate an alarm if timer 212 indicates that a threshold amount of time has elapsed. Timer 212 may be, for example, a timer that counts down from a time equal to the threshold amount of time, or a timer that counts up from zero and triggers an alarm when the timer value is equal to the threshold amount of time. In some implementations, timer 212 may be built into timing module 206 or alarm module 208.

In some implementations, sensor sets 202 and 204, timing module 206, alarm module 208, and timer 212 may all be in an enclosed space. In some implementations, sensor sets 202 and 204 may be in an enclosed space, and timing module 206, alarm module 208, and/or timer 212 may be in a remote location from the enclosed space. For example, timing module 206, alarm module 208, and/or timer 212 may be implemented in a remote server that is communicatively coupled to sensor sets 202 and 204. In some implementations, timing module 206, alarm module 208, and timer 212 may be in different remote locations.

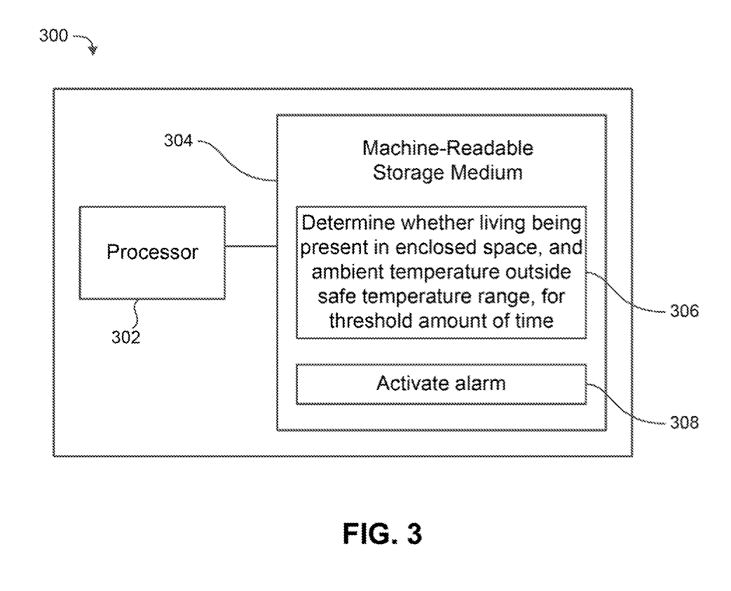

FIG. 3 is a block diagram of an example device 300 that includes a machine-readable storage medium encoded with instructions to enable activation of an alarm when a living being in an enclosed space is subject to extreme temperatures. In some implementations, device 300 may be a computing device in an enclosed space, For example, device 300 may be implemented in a vehicle's theft alarm system, or may be a mobile device (e.g., mobile phone, tablet computing device) in the vehicle or in another enclosed space, such as, but not limited to, a pet container or a room in a medical facility. In some implementations, device 300 may be implemented in a computing device that is remote from an enclosed space, but that is communicatively coupled to sensors in the enclosed space. For example, device 300 may be implemented in a remote server. In FIG. 3, device 300 includes processor 302 and machine-readable storage medium 304.

Processor 302 may include a central processing unit (CPU), microprocessor (e.g., semiconductor-based microprocessor), and/or other hardware device suitable for retrieval and/or execution of instructions stored in machine-readable storage medium 304. Processor 302 may fetch, decode, and/or execute instructions 306 and 308 to enable activation of an alarm when a living being in an enclosed space is subject to extreme temperatures, as described below. As an alternative or in addition to retrieving and/or executing instructions, processor 302 may include an electronic circuit comprising a number of electronic components for performing the functionality of instructions 306 and/or 308.

Machine-readable storage medium 304 may be any suitable electronic, magnetic, optical, or other physical storage device that contains or stores executable instructions. Thus, machine-readable storage medium 304 may include, for example, a random-access memory (RAM), an Electrically Erasable Programmable Read-Only Memory (EEPROM), a storage device, an optical disc, and the like. In some implementations, machine-readable storage medium 304 may include a non-transitory storage medium, where the term “non-transitory” does not encompass transitory propagating signals. As described in detail below, machine-readable storage medium 304 may be encoded with a set of executable instructions 306 and 308.

Instructions 306 may determine whether a living being has been present in an enclosed space, and an ambient temperature of the enclosed space has been outside a safe temperature range, for a threshold amount of time. For example, instructions 306 may determine, based on data received from various passive thermal sensors (e.g., sensor sets 102 and 104, or sensor sets 202 and 204), whether both the conditions of a living being's presence and an ambient temperature outside the safe temperature range have been concurrently satisfied continuously for the threshold amount of time. Instructions 306 may use a default threshold amount of time, or a threshold amount of time set by a person associated with the enclosed space (e.g., a vehicle/pet owner, medical staff).

Instructions 308 may activate an alarm. For example, the alarm may be activated if the living being has been present in the enclosed space, and the ambient temperature of the enclosed space has been outside the safe temperature range, for the threshold amount of time. The alarm may take any or a combination of the forms discussed above with respect to FIG. 1.

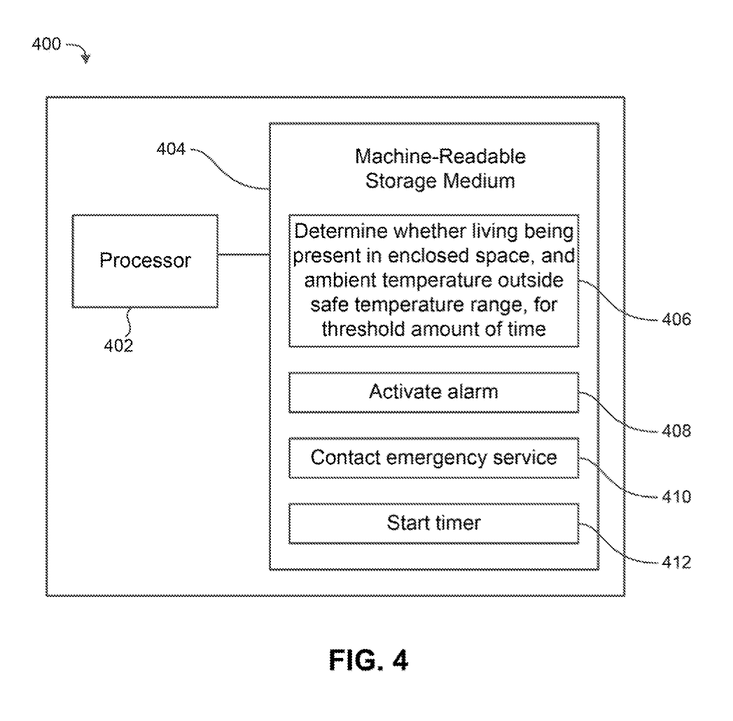

FIG. 4 is a block diagram of an example device 400 that includes a machine-readable storage medium encoded with instructions to enable communication with an emergency service if a living being in an enclosed space is subject to extreme temperatures. In some implementations, device 400 may be a computing device in an enclosed space. For example, device 400 may be implemented in a vehicle's theft alarm system, or may be a mobile device (e.g., mobile phone, tablet computing device) in the vehicle or in another enclosed space, such as, but not limited to, a pet container or a room in a medical facility. In some implementations, device 400 may be implemented in a computing device that is remote from an enclosed space, but that is communicatively coupled to sensors in the enclosed space. For example, device 400 may be implemented in a remote server. In FIG. 4, device 400 includes processor 402 and machine-readable storage medium 404.

As with processor 302 of FIG. 3, processor 402 may include a CPU, microprocessor (e.g., semiconductor-based microprocessor), and/or other hardware device suitable for retrieval and/or execution of instructions stored in machine-readable storage medium 404. Processor 402 may fetch, decode, and/or execute instructions 406, 408, 410, and 412 to enable communication with an emergency service if a living being in an enclosed space is subject to extreme temperatures, as described below. As an alternative or in addition to retrieving and/or executing instructions, processor 402 may include an electronic circuit comprising a number of electronic components for performing the functionality of instructions 406, 408, 410, and/or 412.

As with machine-readable storage medium 304 of FIG. 3, machine-readable storage medium 404 may be any suitable physical storage device that stores executable instructions. Instructions 406 and 408 on machine-readable storage medium 404 may be analogous to instructions 306 and 308, respectively, on machine-readable storage medium 304. In some implementations, instructions 408 may transmit a text or audio alert to a user device of a person associated with an enclosed space to notify the person that a living being in the enclosed space is in danger because of extreme temperatures in the enclosed space. Instructions 410 may contact an emergency service if the person associated with the enclosed space does not respond to the text or audio alert within a response time interval after the text or audio alert is transmitted to the user device. The response time interval may be a default response time interval, or may be set by the person associated with the enclosed space. The emergency service may be, for example, a police station, emergency medical technician (EMT) unit, or hospital near the enclosed space. In some implementations, instructions 410 may transmit geographical coordinates (e.g., GPS coordinates) of the enclosed space to the emergency service, as discussed above with respect to FIG. 1.

Instructions 412 may start a timer in response to receiving a signal indicative of a living being's presence in an enclosed space after receiving a signal indicative of the ambient temperature of the enclosed space being outside a safe temperature range, or in response to receiving the signal indicative of the ambient temperature being outside the safe temperature range after receiving the signal indicative of the living being's presence. The timer (e.g., timer 212) may count down or count up to a threshold amount of time, as discussed above with respect to FIG. 2. Instructions 408 may activate an alarm if the timer indicates that the threshold amount of time has elapsed. The activated alarm may take any or a combination of the forms discussed above with respect to FIG. 1.

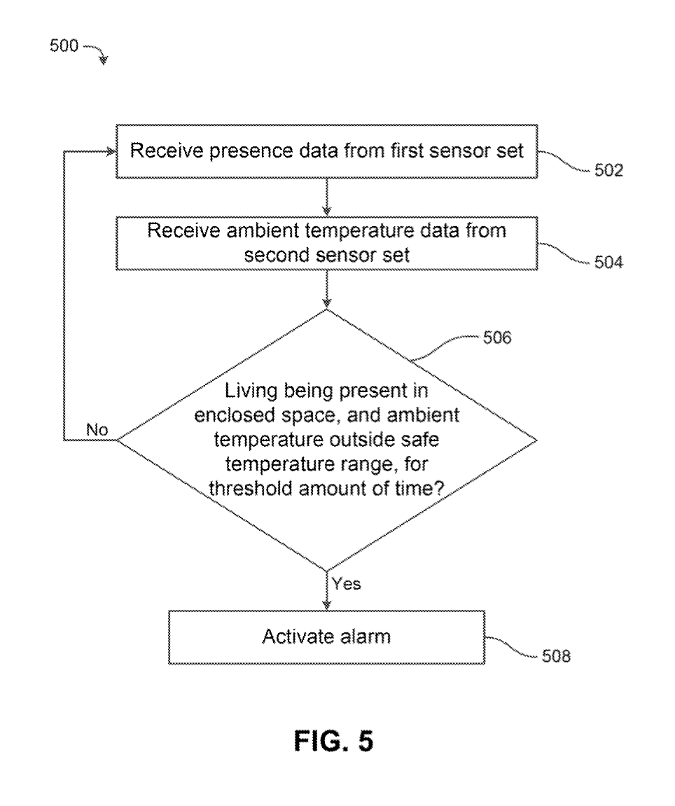

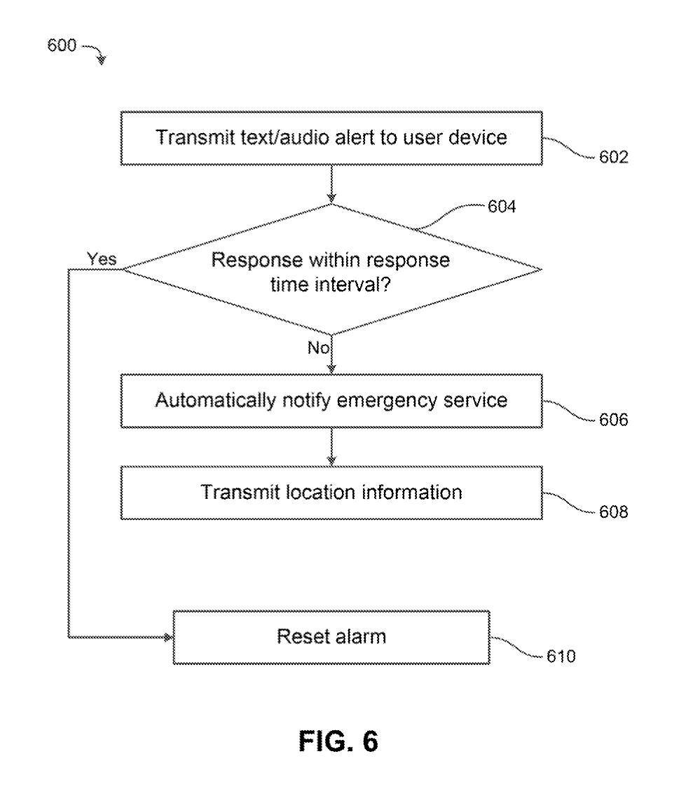

Methods related to triggering alarms for living beings present in enclosed spaces with extreme temperatures are discussed with respect to FIGS. 5-6. FIG. 5 is a flowchart of an example method 500 for activating an alarm when a living being in an enclosed space is subject to extreme temperatures. Although execution of method 500 is described below with reference to processor 302 of FIG. 3, it should be understood that execution of method 500 may be performed by other suitable devices, such as processor 402 of FIG. 4. Method 500 may be implemented in the form of executable instructions stored on a machine-readable storage medium and/or in the form of electronic circuitry.

Method 500 may start in block 502, where processor 302 may receive, from a first sensor set, presence data indicative of whether a living being is present in an enclosed space. For example, processor 302 may receive presence data from sensor set 102 or 202. In some implementations, the first sensor set may include passive thermal sensors.

In block 504, processor 302 may receive, from a second sensor set, ambient temperature data indicative of whether an ambient temperature of the enclosed space is outside a safe temperature range. For example, processor 302 may receive presence data from sensor set 104 or 204. In some implementations, the second sensor set may include passive thermal sensors. Although block 504 is shown below block 502 in FIG. 5, it should be understood that elements of block 504 may be performed before or in parallel with elements of block 502.

In block 506, processor 302 may determine, based on the presence data and ambient temperature data, whether the living being has been present in the enclosed space, and the ambient temperature of the enclosed space has been outside the safe temperature range, for a threshold amount of time. In some implementations, processor 302 may use a timer to make such a determination, as discussed above with respect to FIG. 2. If, in block 506, processor 302 determines either that the living being has not been present in the enclosed space for the threshold amount of time, or that the ambient temperature of the enclosed space has not been outside the safe temperature range for the threshold amount of time, method 500 may loop back to block 502.

If, in block 506, processor 302 determines that the living being has been present in the enclosed space, and the ambient temperature of the enclosed space has been outside the safe temperature range, for the threshold amount of time, method 500 may proceed to block 508, in which processor 302 may activate an alarm. The activated alarm may take any or a combination of the forms discussed above with respect to FIG. 1. In some implementations, the enclosed space may be a vehicle, and activating the alarm may include activating an alarm system of the vehicle. In some implementations, activating the alarm system of the vehicle may include using lights and a horn of the vehicle to transmit a distress signal, as discussed above with respect to FIG. 1.

FIG. 6 is a flowchart of an example method 600 for notifying an emergency service if a living being in an enclosed space is subject to extreme temperatures. Although execution of method 600 is described below with reference to processor 402 of FIG. 4, it should be understood that execution of method 600 may be performed by other suitable devices, such as processor 302 of FIG. 3. Some blocks of method 600 may be performed in parallel with and/or after method 500. Method 600 may be implemented in the form of executable instructions stored on a machine-readable storage medium and/or in the form of electronic circuitry.

Method 600 may start in block 602, where processor 402 may transmit a text or audio alert to a user device of a person associated with an enclosed space. The text or audio alert may comprise an alarm that is activated when a living being has been present in an enclosed space, and the ambient temperature of the enclosed space has been outside a safe temperature range, for a threshold amount of time. The person associated with the enclosed space may be, for example, a pet/vehicle owner or medical staff, and the user device may be, for example, a pager or smartphone, as discussed above with respect to FIG. 1.

In block 604, processor 402 may determine whether the person associated with the enclosed space has responded to the text or audio alert within a response time interval after the text or audio alert is transmitted to the user device. For example, processor 402 may determine whether the person answered a call, listened to a voicemail, or opened a text message transmitted by processor 402. If, in block 604, processor 402 determines that the person has responded within the response time interval, method 600 may proceed to block 610, in which processor 402 may reset an alarm. For example, processor 402 may stop a user device from beeping or vibrating, and/or stop a vehicle's lights and horn from flashing and sounding, respectively. In some implementations, processor 402 may reset a timer (e.g., timer 212).

If, in block 604, processor 402 determines that the person associated with the enclosed space has not responded to the text or audio alert within the response time interval, method 600 may proceed to block 606, in which processor 402 may automatically notify an emergency service about the living being in the enclosed space. The emergency service may be, for example, a police station, an EMT unit, or a hospital. In block 608, processor 402 may transmit, to the emergency service, location information for the enclosed space. For example, processor 402 may transmit GPS coordinates of the enclosed space to the emergency service, as discussed above with respect to FIG. 1.

The foregoing disclosure describes automatic activation of an alarm if a living being is in an enclosed space with an unsafe ambient temperature for a certain period of time. Example implementations described herein enable an entity outside the enclosed space to be notified of the potential harm to the living being due to extreme temperatures, so that appropriate action may be taken to prevent such harm.

We claim:

1. A system comprising:
a first sensor set to determine whether a living being is present in an enclosed space;
a second sensor set to determine whether an ambient temperature of the enclosed space is outside a safe temperature range, wherein the first and second sensor sets comprise passive thermal sensors;
a timing module, communicatively coupled to the first and second sensor sets. to determine whether the living being has been present in the enclosed space, and the ambient temperature of the enclosed space has been outside the safe temperature range, for a threshold amount of time; and
an alarm module, communicatively coupled to the timing module, to activate an alarm if the living being has been present in the enclosed space, and the ambient temperature of the enclosed space has been outside the safe temperature range, for the threshold amount of time.

2. The system of claim 1, wherein the activated alarm comprises flashing lights along an exterior surface of the enclosed space.

3. The system of claim 1, wherein the activated alarm comprises playing a pre-recorded message through a speaker along an exterior surface of the enclosed space.

4. The system of claim 1, wherein:
the activated alarm comprises a text or audio alert transmitted from the alarm module to a user device of a person associated with the enclosed space; and
the alarm module is further to automatically contact an emergency service if the person associated with the enclosed space does not respond to the text or audio alert within a response time interval after the text or audio alert is transmitted to the user device.

5. The system of claim 1, wherein:
the first and second sensor sets are further to determine absolute temperatures in respective fields of view of the first and second sensor sets;
the timing module is further to determine whether a temperature of the living being and the ambient temperature of the enclosed space diverge for a predetermined amount of time; and
the alarm module is further to activate the alarm if the temperature of the living being and the ambient temperature of the enclosed space diverge for the predetermined amount of time.

6. The system of claim 1, wherein the first sensor set further comprises a presence determination module to:
determine temperatures in different areas of a field of view of the first sensor set;
identify an area of the field of view that has a different temperature than other areas of the field of view; and
determine whether the identified area includes a living being.

7. The system of claim 1, wherein:
the first sensor set is to transmit, to the timing module if the first sensor set determines that the living being is present in the enclosed space, a signal indicative of the living being's presence; and
the second sensor set is to transmit, to the timing module if the second sensor set determines that the ambient temperature of the enclosed space is outside the safe temperature range, a signal indicative of the ambient temperature being outside the safe temperature range.

8. The system of claim 7, wherein:
the timing module is further to start a timer in response to receiving the signal indicative of the living being's presence after receiving the signal indicative of the ambient temperature being outside the safe temperature range, or in response to receiving the signal indicative of the ambient temperature being outside the safe temperature range after receiving the signal indicative of the living being's presence; and
the alarm module is further to activate the alarm if the timer indicates that the threshold amount of time has elapsed.

9. A machine-readable storage medium encoded with instructions executable by a processor, the machine-readable storage medium comprising:
instructions to determine whether a living being has been present in an enclosed space, and an ambient temperature of the enclosed space has been outside a safe temperature range, for a threshold amount of time; and
instructions to activate an alarm if the living being has been present in the enclosed space, and the ambient temperature of the enclosed space has been outside the safe temperature range, for the threshold amount of time.

10. The machine-readable storage medium of claim 9, wherein the activated alarm comprises a text or audio alert transmitted to a user device of a person associated with the enclosed space, the machine-readable storage medium further comprising instructions to contact an emergency service if the person associated with the enclosed space does not respond to the text or audio alert within a response time interval after the text or audio alert is transmitted to the user device.

11. The machine-readable storage medium of claim 9, further comprising:
instructions to start a timer in response to receiving a signal indicative of the living being's presence after receiving a signal indicative of the ambient temperature being outside the safe temperature range, or in response to receiving the signal indicative of the ambient temperature being outside the safe temperature range after receiving the signal indicative of the living being's presence; and
instructions to activate the alarm if the timer indicates that the threshold amount of time has elapsed.

12. A method comprising:
receiving, from a first sensor set, presence data indicative of whether a living being is present in an enclosed space;
receiving, from a second sensor set, ambient temperature data indicative of whether an ambient temperature of the enclosed space is outside a safe temperature range;
determining, based on the presence data and ambient temperature data, whether the living being has been present in the enclosed space, and the ambient temperature of the enclosed space has been outside the safe temperature range, for a threshold amount of time; and
activating an alarm if the living being has been present in the enclosed space, and the ambient temperature of the enclosed space has been outside the safe temperature range, for the threshold amount of time.

13. The method of claim 12, wherein activating the alarm comprises transmitting a text or audio alert to a user device of a person associated with the enclosed space, the method further comprising:
automatically notifying, if the person associated with the enclosed space does not respond to the text or audio alert within a response time interval after the text or audio alert is transmitted to the user device, an emergency service about the living being in the enclosed space; and
transmitting, to the emergency service, location information for the enclosed space.

14. The method of claim 12, wherein:
the first and second sensor sets comprise passive thermal sensors;
the enclosed space is a vehicle; and
activating the alarm comprises activating an alarm system of the vehicle.

15. The method of claim 14, wherein activating the alarm system of the vehicle comprises using lights and a horn of the vehicle to transmit a distress signal.
